(19) United States
(12) Patent Application Publication
(10) Pub. No.: US 2026/0160642 A1
(43) Pub. Date: Jun. 11, 2026

(54) REAL-CONDITION SIMULATION TEST SYSTEM FOR AUTOMOBILE STEERING GEAR

(71) Applicants: SHANGHAI UNIVERSITY OF MEDICINE & HEALTH SCIENCES, Shanghai (CN); SUZHOU XIACHENG INTELLIGENT TECHNOLOGY CO., LTD., Suzhou (CN)

(72) Inventors: Jiachen GUO, Suzhou (CN); Chao YI, Suzhou (CN); Tianlei ZHENG, Suzhou (CN)

(73) Assignees: SHANGHAI UNIVERSITY OF MEDICINE & HEALTH SCIENCES, Shanghai (CN); SUZHOU XIACHENG INTELLIGENT TECHNOLOGY CO., LTD., Suzhou (CN)

(21) Appl. No.: 19/387,126

(22) Filed: Nov. 12, 2025

(30) Foreign Application Priority Data
Dec. 11, 2024 (CN) 202411818488.9

(51) Int. Cl. G01M 13/021; G01M 13/025; G01M 17/007

(52) U.S. Cl. CPC G01M 13/021; G01M 13/025; G01M 17/007

(57) ABSTRACT

A real-condition simulation test system for an automobile steering gear. A mounting platform is arranged at a middle position of the bottom of a box body, seven nozzles are arranged on each of front and rear sidewalls of the box body; each nozzle can spray a mud-water mixture while oscillating; a left cover and a right cover are mounted at an upper end of the box body via hinges. A first connecting frame, a first rotating frame, a threaded hole slider, an acorn nut, an end connector and a damper form a set of resistance guiding and adjusting device; the resistance of the damper can be adjusted according to a magnetic field intensity. Two sets of resistance guiding and adjusting devices are mounted on each of left and right sidewalls of the box body. Two steering gears are fixedly mounted on the mounting platform.

### CROSS-REFERENCE TO RELATED APPLICATIONS

This application claims foreign priority benefits under 35 U.S.C. § 119(a)-(d) to Chinese Patent Application No. 202411818488.9, filed Dec. 11, 2024, which is hereby incorporated herein by reference in its entirety.

### TECHNICAL FIELD

The present disclosure relates to the technical field of automobile steering gear tests, and in particular to a real-condition simulation test system for an automobile steering gear.

### BACKGROUND

In recent years, automobile manufacturing technology in China has made great progress and achieved fruitful results. In the process of automobile production and manufacturing, the durability test of parts is very necessary. However, the real vehicle test is not only highly dangerous but also expensive. Manufacturers prefer to use test equipment to simulate the test under different working conditions. This way is not only safe, convenient and low-cost, but also achieves relatively ideal results. Steering gear, as one of the most important parts of automobile, needs to undergo strict performance test and durability test during production to verify its reliability and obtain the optimal working state. REPS steering system (rack-type electric power steering system) is a widely used steering gear mechanism. In the REPS steering system, a power-assisted system, in which a motor is directly arranged on a rack, amplifies the power-assisted motor through a belt and ball screw transmission mechanism, thereby assisting a driver to steer the vehicle while driving. Moreover, a mud-water test is a conventional DV/PV test that must be conducted for REPS, so it is very necessary to develop a real-condition simulation test system specifically for REPS.

### SUMMARY

To solve the disadvantages in the prior art, an objective of the present disclosure is to provide a real-condition simulation test system for an automobile steering gear. The real-condition simulation test system for an automobile steering gear includes a box body, a damper, a first connecting frame, a left cover, a right cover, water inlet pipes, spiral hoses, a sealing cover, an oscillating plate, nozzles, an oscillating plate, an input motor, a stepped pulley, an end connector, a threaded hole slider, a left oscillating arm, a movable positioning frame, a right oscillating arm, an upper left shaft, a lower left shaft, an upper right shaft, a lower right shaft, a right sliding positioning block, a right locking rotation knob, a right positioning knob, a left positioning knob, a left locking rotation knob, and a left sliding positioning block. A front T-shaped groove and a rear T-shaped groove are arranged in a front side and a rear side inside the box body, respectively; seven ball-and-socket structures are arranged on each of a front box wall and a rear box wall of the box body; a mounting platform is arranged at a middle position of a bottom of the box body, two beveled structures are arranged on each of a left side and a right side of the mounting platform, and a bottom end of each of the two beveled structures is transversely provided with a water filter hole and a water outlet pipe. Seven nozzles are arranged on each of a front sidewall and a rear sidewall of the box body, and each of the seven nozzles is capable of spraying a mud-water mixture while oscillating. Two water inlet pipes are arranged on a front side and a rear side of the box body, and each of the two water inlet pipes is in communication with corresponding nozzles through seven spiral hoses; and the left cover and the right cover are mounted at an upper end of the box body via hinges. A triangular arc plate at a left end of the first connecting frame and a first annular frame at a right end of the first connecting frame are connected to a whole via three circular guide rods in the first connecting frame, and a first rotating frame is mounted at a right side of the first annular frame to form a revolute pair. The threaded hole slider is mounted inside the first rotating frame to form a prismatic pair; the end connector is positioned through the acorn nut and the threaded hole slider. A cavity inside the damper is filled with magnetorheological fluid, and an electromagnetic coil is arranged inside a sidewall of the damper. A piston plate at a middle position of a damping guide rod is provided with three through holes, the piston plate is configured to divide the magnetorheological fluid inside the damper into a left portion and a right portion, and resistance of the damper is adjustable by a magnetic field intensity of the electromagnetic coil. The damper is located at a center position of the first connecting frame, and two ends of the damping guide rod are fastened to two ends of the first connecting frame. The first connecting frame is mounted on a left sidewall of the box body to form a prismatic pair, and the damper inside the first connecting frame is fixedly connected to the box body. The first connecting frame, the first rotating frame, the threaded hole slider, the acorn nut, the end connector and the damper form a set of resistance guiding and adjusting device; two sets of the resistance guiding and adjusting devices are mounted on each of the left sidewall and a right sidewall of the box body; a first steering gear and a second steering gear are fixedly mounted on the mounting platform, and both ends of each of the first steering gear and the second steering gear are connected to corresponding resistance guiding and adjusting devices, respectively. A sliding positioning groove is formed in a middle position of the oscillating plate, two ends of the oscillating plate are rotatably connected to the left sliding positioning block and the right sliding positioning block, respectively, the left sliding positioning block and the right sliding positioning block are respectively mounted in the rear T-shaped groove and the front T-shaped groove to form prismatic pairs; the left positioning knob and the right positioning knob are configured to lock positions of the left sliding positioning block and the right sliding positioning block by thread structures, respectively. The left locking rotation knob and the right locking rotation knob are mounted at two ends of the oscillating plate and configured to lock a tilt angle of the oscillating plate by thread structures. The movable positioning frame and the input motor are mounted at an upper side and a lower side of the sliding positioning groove, respectively; and rear ends of the left oscillating arm and the right oscillating arm are both rotatably mounted on the movable positioning frame. Two pulleys are coaxially arranged on the stepped pulley, and the stepped pulley is fastened to an output shaft of the input motor through a stepped pulley shaft. The upper left shaft and the upper right shaft are rotatably mounted on front ends of the left oscillating arm and the right oscillating arm, respectively; the stepped pulley is configured to drive the upper left shaft and the upper right shaft to rotate through two synchronous belts; upper ends of the lower left shaft and the lower right shaft are respectively mounted inside the upper left shaft and the upper right shaft and capable of extending or retracting; and lower ends of the lower left shaft and the lower right shaft are connected to input shafts of the first steering gear and the second steering gear, respectively.

In a further embodiment of the present disclosure, multiple inclined through drainage holes are arranged below each of the front T-shaped groove and the rear T-shaped groove; an upper end of each drainage hole is in communication with an inside of the front T-shaped groove or in communication with an inner of the rear T-shaped groove; and a lower end of each drainage hole is in communication with the inside of the box body; the drainage hole is capable of guiding muddy water in a side T-shaped groove into the box body.

In a further embodiment of the present disclosure, an annular T-shaped groove is arranged inside the right side of the first annular frame, two arc sliders are arranged on two ends of a left side of the first rotating frame, and the two arc sliders are mounted in the annular T-shaped groove inside the first annular frame, thereby enabling the first rotating frame to rotate freely. A straight T-shaped groove is arranged inside a right side of the first rotating frame.

In a further embodiment of the present disclosure, two pulleys are coaxially arranged on the stepped pulley, and a diameter of a lower pulley of the two pulleys is greater than a diameter of an upper pulley of the two pulleys.

In a further embodiment of the present disclosure, the input motor, the left oscillating arm, the right oscillating arm and related connecting components are sealed by a sealing cover, and the sealing cover is made of flexible rubber.

In a further embodiment of the present disclosure, a front end of the nozzle is provided with a spray orifice, a rear end of the spray orifice is provided with one positioning spherical surface, an oscillating spherical surface is arranged behind the positioning spherical surface, and a rear end of the oscillating spherical surface is provided with one interface.

In a further embodiment of the present disclosure, each of the left cover and the right cover is provided with a transparent observation window.

Compared to the prior art, the present disclosure has beneficial effects as follows. (1) Steering gears of different models have different input shaft positions and different input shaft tilt angles, so that an oscillating plate can move side to side to adjust the position and oscillate up and down to adjust the tilt angle, thereby meeting the requirements of connecting input shafts of different steering gears of different models. (2) The resistance of each of the four connecting frames can be adjusted according to an internal coil magnetic field intensity, and the greater the coil magnetic field intensity, the greater the resistance, so that a corresponding resistance value can be set according to the different steering gear models to simulate an actual working load of the steering gear. (3) Two pulleys are coaxially arranged on the tower pulley, and a diameter of a lower pulley is larger than that of an upper pulley, so that transmission ratios between the input motor and input shafts of the two steering gears are different, enabling the two steering gears to work with different rotating speeds to each other, thus simulating working conditions of the steering gear under different rotating speeds. (4) An inner end of each connecting frame is provided with an annular frame, and a rotating frame is mounted on the annular frame to form a revolute pair; the rotating frame is provided with a straight T-shaped groove, and a movable threaded hole slider is arranged in the straight T-shaped groove; and an end connector and the threaded hole slider form a thread pair, so that the end connector can be positioned at any position inside the annular frame to further meet connection requirements of steering gears of different models.

### BRIEF DESCRIPTION OF THE DRAWINGS

FIG. 1 is a schematic diagram of an overall structure according to an embodiment of the present disclosure;

FIG. 2 is a schematic diagram of an overall structure according to an embodiment of the present disclosure;

FIG. 3 is a schematic diagram of a longitudinal sectional structure according to an embodiment of the present disclosure;

FIG. 4 is a partially enlarged sectional view at a position of a first connecting frame according to an embodiment of the present disclosure;

FIG. 5 is a schematic diagram of a transverse sectional structure according to an embodiment of the present disclosure;

FIG. 6 is a schematic diagram of the principle of a nozzle oscillating structure according to an embodiment of present disclosure;

FIG. 7 is a schematic diagram of the structure of a movable positioning frame according to an embodiment of the present disclosure;

FIG. 8 is a schematic diagram of the structure of an oscillating plate according to an embodiment of the present disclosure;

FIG. 9 is a schematic diagram of the structure of a nozzle according to an embodiment of the present disclosure;

FIG. 10 is a schematic diagram of the structure of a first crankshaft wheel according to an embodiment of the present disclosure.

Reference numerals: 1—box body; 101—first water outlet pipe; 102—second water outlet pipe; 103—front T-shaped groove; 104—right drainage hole; 105—relief notch; 106—first water filter hole; 107—second water filter hole; 108—mounting platform; 109—left drainage hole; 2—damper; 201—damping guide rod; 3—first connecting frame; 301—first annular frame; 302—first rotating frame; 4—second connecting frame; 401—second annular frame; 402—second rotating frame; 5—side sealing cover; 6—left cover; 7—right cover; 8—fourth connecting frame; 801—fourth annular frame; 802—fourth rotating frame; 9—water inlet pipe; 10—spiral hose; 11—sealing cover; 12—third connecting frame; 1201—third annular frame; 1202—third rotating frame; 13—oscillating plate; 1301—follower lug; 14—nozzle; 1401—positioning spherical surface; 1402—oscillating spherical surface; 15—first steering gear; 16—second steering gear; 17—oscillating plate; 1701—sliding positioning groove; 1702—right threaded holed; 1703—left threaded hole; 18—input motor; 19—right pulley; 20—left pulley; 21—left synchronous belt; 22—right synchronous belt; 23—stepped pulley; 24—end connector; 25—acorn nut; 26—threaded hole slider; 27—stepped pulley shaft; 28—left oscillating arm; 29—movable positioning frame; 2901—square plate; 2902—plain shaft; 30—right oscillating arm; 31—upper left shaft; 32—lower left shaft; 33—upper right shaft; 34—lower right shaft; 35—right sliding positioning block; 36—right locking rotation knob; 37—right positioning knob; 38—left positioning knob; 39—left locking rotation knob; 40—left sliding positioning block; 41—first crankshaft wheel; 4101—rotating shaft; 4102—nozzle pulley; 4103—circular plate; 4104—actuating shaft; 42—second crankshaft wheel; 43—first guide wheel; 44—drive wheel; 45—nozzle oscillating motor; 46—second guide wheel; 47—nozzle oscillating synchronous belt.

### DETAILED DESCRIPTION

The present disclosure is further described below with reference to specific embodiments, and illustrative embodiments and descriptions of the present disclosure are used to explain the present disclosure, but do not serve as limitations of the present disclosure.

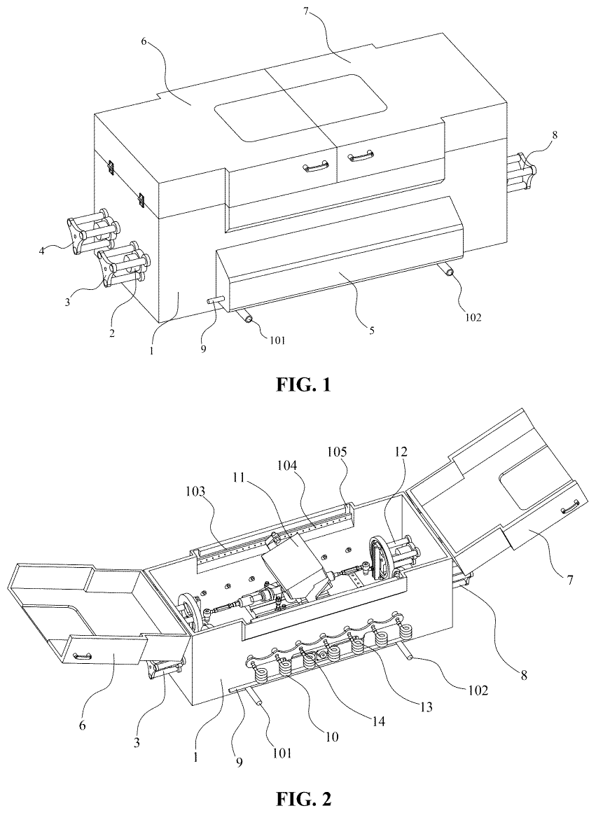

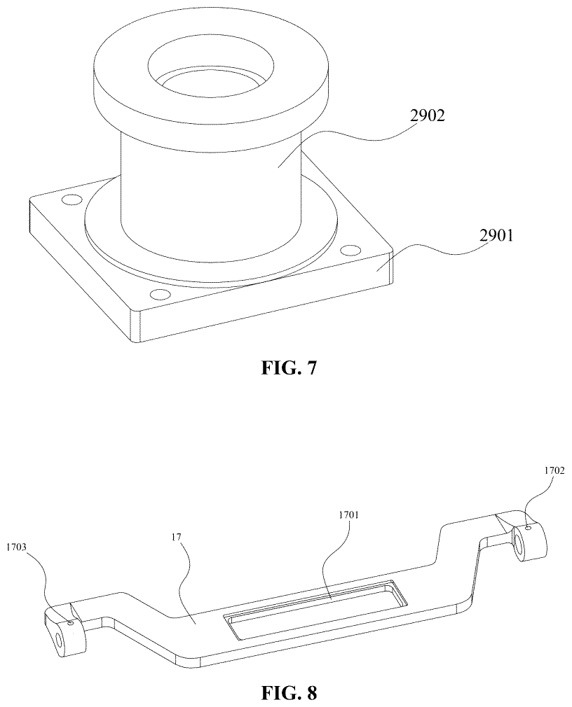

As shown in FIG. 1 to FIG. 10, a real-condition simulation test system for an automobile steering gear mainly includes a box body 1, a damper 2, a first connecting frame 3, a second connecting frame 4, a side sealing cover 5, a left cover 6, a right cover 7, a fourth connecting frame 8, water inlet pipes 9, spiral hoses 10, a sealing cover 11, a third connecting frame 12, an oscillating plate 13, a nozzle 14, a first steering gear 15, a second steering gear 16, an oscillating plate 17, an input motor 18, a right pulley 19, a left pulley 20, a left synchronous belt 21, a right synchronous belt 22, a stepped pulley 23, an end connector 24, an acorn nut 25, a threaded hole slider 26, a stepped pulley shaft 27, a left oscillating arm 28, a movable positioning frame 29, a right oscillating arm 30, an upper left shaft 31, a lower left shaft 32, an upper right shaft 33, a lower right shaft 34, a right sliding positioning block 35, a right locking rotation knob 36, a right positioning knob 37, a left positioning knob 38, a left locking rotation knob 39, a left sliding positioning block 40, a first crankshaft wheel 41, a second crankshaft wheel 42, a first guide wheel 43, a drive wheel 44, a nozzle oscillating motor 45, a second guide wheel 46, and a nozzle oscillating synchronous belt 47. A front T-shaped groove 103 is longitudinally arranged on an upper end of a front side inside the box body 1, multiple inclined through right drainage holes 104 are arranged below the front T-shaped groove 103, an upper end of each right drainage hole 104 is in communication with the inside of the front T-shaped groove 103, a lower end of each right drainage hole 104 is in communication with the inside of the box body 1, the right drainage hole 104 can guide muddy water in the front T-shaped groove 103 into the box body 1 to avoid blockage in the front T-shaped groove 103, and two ends of the front T-shaped groove 103 are provided with two relief notches 105. A rear T-shaped groove is transversely arranged at an upper end of a rear side inside the box body 1, multiple inclined through left drainage holes 109 are arranged below the rear T-shaped groove, an upper end of each left drainage hole 109 is in communication with the inside of the rear T-shaped groove, a lower end of each left drainage hole 109 is in communication with the inside of the box body 1, the left drainage hole 109 can guide muddy water in the rear T-shaped groove into the box body to avoid blockage in the rear T-shaped groove, and two ends of the rear T-shaped groove are provided with two relief notches. Seven ball-and-socket structures are longitudinally and equidistantly arranged in a front box wall of the box body 1, seven ball-and-socket structures are longitudinally and equidistantly arranged in a rear box wall of the box body 1, and the positions of the front and rear groups of ball-and-socket structures are in correspondence to each other. A mounting platform 108 is mounted at a middle position of the bottom of the box body 1, and the mounting platform 108 is longitudinally provided with multiple inverted T-shaped grooves. The mounting platform 108 can be configured to mount a tested steering gear. Two beveled structures are arranged on a left side of the mounting platform 108, multiple first water filter holes 106 are transversely formed in bottom ends of the two beveled structures, and lower ends of all first water filter holes 106 are in communication with a first water outlet pipe 101. Further two beveled structures are arranged on a right side of the mounting platform 108, multiple second water filter holes 107 are transversely formed in bottom ends of the further two beveled structures, and lower ends of all second water filter holes 107 are in communication with a second water outlet pipe 102. The first water outlet pipe 101 and the second water outlet pipe 102 are configured to drain muddy water used in test, and both in communication with a muddy water supply device to achieve circulation. The left cover 6 is provided with a transparent glass observation window, a left end of the left cover 6 is mounted at a left end of an upper side of the box body 1 via a hinge, and two handles are arranged on front and rear sides of a right end of the left cover 6 to facilitate the open/close of the left cover 6. The right cover 7 is provided with a transparent glass observation window, a right end of the right cover 7 is mounted at a right end of the upper side of the box body 1 via a hinge, and two handles are arranged on front and rear sides of a left end of the right cover 7 to facilitate the open/close of the right cover 7.

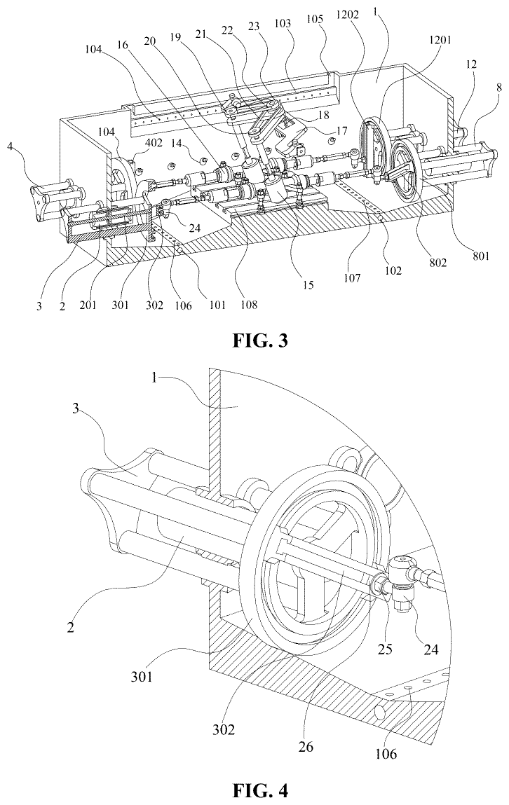

As shown in FIG. 3 and FIG. 4, three circular guide rods are arranged on the first connecting frame 3, right ends of the three circular guide rods are fastened to a first annular frame 301, and left ends of the three circular guide rods are fixedly connected via a triangular arc plate. The first connecting frame 3 is mounted on a left sidewall of the box body 1 and can move side to side, and an annular T-shaped groove is formed inside a right side of the first annular frame 301. The first rotating frame 302 is of a flat plate structure, two arc sliders are arranged at two ends of a left side of the first rotating frame 302, and the two arc sliders are mounted in the annular T-shaped groove inside the first annular frame 301, so that the first rotating frame 302 can rotate freely, and a straight T-shaped groove is arranged inside a right side of the first rotating frame 302. The threaded hole slider 26 is of a square block structure, with a threaded hole arranged at its center position. The threaded hole slider is mounted in the straight T-shaped groove inside the first rotating frame 302 to form a prismatic pair. A round connecting hole is vertically formed in a right end of the end connector 24, a left end of the end connector 24 is of a horizontal threaded rod structure, the acorn nut 25 is mounted at the left end of the end connector 24 to form a thread pair, and the left end of the end connector 24 is mounted in a threaded hole at the center of the threaded hole slider 26 to form a thread pair. After rotating the acorn nut 25 to press against the first rotating frame 302, a position of the end connector 24 on the first rotating frame 302 can be secured by applying the double-nut locking principle.

The damper 2 is internally provided with a sealed cavity, the cavity is filled with magnetorheological fluid, and an electromagnetic coil is arranged inside a sidewall of the damper 2. A piston plate is arranged at a middle position of a damping guide rod 201, three through holes are equidistantly formed in the piston plate, the damping guide rod 201 is mounted inside the damper 2, and the piston plate divides the cavity of the damper 2 into left and right portions. The magnetorheological fluid in the left and right portions can achieve communication through the three through holes in the piston plate. The electromagnetic coil can generate a magnetic field in the damper 2 after being electrified, the magnetorheological fluid can change its own viscosity according to the magnetic field intensity to achieve the regulation of resistance of the damper. The damper 2 is fixedly mounted on the left sidewall of the box body 1 and located at a center position inside the first annular frame 301. In addition, a left end of the damping guide rod 201 is fixedly connected to the triangular arc plate at the left end of the first connecting frame 3, a right end of the damping guide rod 201 is fixedly connected to the first annular frame 301 at the right end of the first connecting frame 3, so that the first connecting frame 3 can drive the damping guide rod 201 to move side to side, making the magnetorheological fluid in the cavity of the damper 2 flow between the left and right sides of the piston plate, thereby providing the resistance to the left and right movement of the first connecting frame 3. Therefore, the resistance of wheel rotation under actual working conditions can be simulated.

The second connecting frame 4 has a same structure as the first connecting frame 3, a right end of the second connecting frame 4 is provided with a second annular frame 401, and the second annular frame 402 has a same structure as the first rotating frame 302. The second rotating frame 402 is mounted at a right side of the second annular frame 401 to form a revolute pair, and a movable threaded hole slider is arranged in a straight T-shaped groove inside the second connecting frame 402. One end connector and one acorn nut are also arranged on the right side of the threaded hole slider; and the acorn nut and the threaded hole slider are configured to secure the position of the end connector on the second rotating frame 402 through the double-nut locking principle. The second connecting frame 4 is mounted on the left sidewall of the box body 1 and can move side to side, the second connecting frame 4 is located at a front side of the first connecting frame 3, one damper is also arranged at a center position inside the second connecting frame 4, and two ends of a damping guide rod in the damper are fixedly connected to two ends of the second connecting frame 4, respectively. The third connecting frame 12 and the second connecting frame 4 are same in structure but opposite in mounting direction, a third annular frame 1201 is arranged at a left end of the third connecting frame 12, and the third annular frame 1201 has a same structure as the second annular frame 401. The third rotating frame 1202 has a same structure as the second rotating frame 402, the third rotating frame 1202 is mounted on a left side of the third annular frame 1201 to form a revolute pair, and a movable threaded hole slider is arranged in a straight T-shaped groove inside the third rotating frame 1202. One end connector and one acorn nut are also arranged on a left side of the threaded hole slider; and the acorn nut and the threaded hole slider are configured to secure the position of the end connector on the third rotating frame 1202 through the double-nut locking principle. The third connecting frame 12 is mounted on the right sidewall of the box body 1 and can move side to side, a position of the third connecting frame 12 coaxially corresponds to that of the second connecting frame 4, and one damper is also arranged at a center position inside the third connecting frame 12. Two ends of a damping guide rod in the damper are fixedly connected to two ends of the third connecting frame 12, respectively. A fourth connecting frame 8 has a same structure as the third connecting frame 12, a fourth annular frame 801 is arranged at a left end of the fourth connecting frame 8, the fourth annular frame 801 has a same structure as the third annular frame 1201, the fourth rotating frame 802 has a same structure as the third rotating frame 1201, the fourth rotating frame 802 is mounted at the left side of the fourth annular frame 801 to form a revolute pair, and one movable threaded hole slider is arranged in a straight T-shaped groove inside the fourth rotating frame 802. One end connector and one acorn nut are also arranged on the left side of the threaded hole slider; and the acorn nut and the threaded hole slider are configured to secure the position of the end connector on the fourth rotating frame 802 through the double-nut locking principle. The fourth connecting frame 8 is mounted on the right sidewall of the box body 1 and can move side to side, a position of the fourth connecting frame 8 coaxially corresponds to that of the first connecting frame 3, and one damper is also arranged at a center position inside the fourth connecting frame 8. Two ends of a damping guide rod in the damper are fixedly connected to two ends of the fourth connecting frame 8, respectively.

The first steering gear 15 and the second steering gear 16 are both fixedly mounted on the mounting platform 108 via bolts. A left end of the first steering gear 15 is fastened to the end connector 24 at a right side of the first rotating frame 302, and a right end of the first steering gear 15 is fastened to the end connector at a left side of the fourth rotating frame 802. A left end of the second steering gear 16 is fastened to the end connector at a right side of the second rotating frame 402, and a right end of the second steering gear 16 is fastened to the end connector at a left side of the third rotating frame 1202.

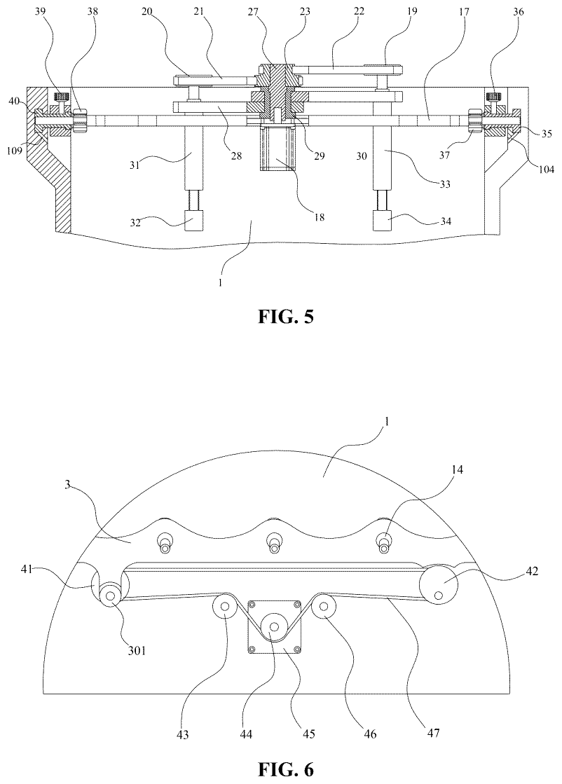

As shown in FIG. 3 and FIG. 5, a right end of the right sliding positioning block 35 is of a square block structure, a left end of the right sliding positioning block 35 is provided with a stepped cylindrical structure, a through threaded hole is formed in the right sliding positioning block 35, and the square block structure at the right end of the right sliding positioning block 35 is mounted in the front T-shaped groove 103 to form a prismatic pair. A left end of the right positioning knob 37 is of a knob structure, and a right end of the right positioning knob 37 is of a threaded rod structure. The right positioning knob 37 is coaxially mounted in the threaded hole in the right sliding positioning block 35. Clockwise rotation of the right positioning knob 37 can enable the right end of the right positioning knob to press against the front T-shaped groove 103, thereby securing a position of the right sliding positioning block 35. Counterclockwise rotation of the right positioning knob 37 can release the right sliding positioning block 35 from locking. The left sliding positioning block 40 and the right sliding positioning block 35 are left-right symmetrical in structure, and a square block structure at a left end of the left sliding positioning block 40 is mounted in the rear T-shaped groove to form a prismatic pair. The left positioning knob 38 and the right positioning knob 37 are left-right symmetrical in structure, and the left positioning knob 38 is coaxially mounted in a threaded hole in the left sliding positioning block 40. Clockwise rotation of the left positioning knob 38 can enable the left end of the left positioning knob to press against the rear T-shaped groove, thereby securing a position of the left sliding positioning block 40. Counterclockwise rotation of the left positioning knob 38 can release the left sliding positioning block 40 from locking.

As shown in FIG. 5 and FIG. 8, a main body of the oscillating plate 17 is of a plate structure, and a middle position of the oscillating plate 17 is provided with one sliding positioning groove 1701. Two coaxial and left-right symmetrical stepped circular holes are formed in two ends of the oscillating plate 17, one right threaded hole 1702 is vertically formed in an upper side of the right stepped circular hole, and a left threaded hole 1703 is vertically formed in an upper side of the left stepped circular hole. The oscillating plate 17 is mounted on the upper side of the box body 1, a left end of the oscillating plate 17 is rotatably connected to a right end of the left sliding positioning block 40, and a right end of the oscillating plate 17 is rotatably connected to a left end of the right sliding positioning block 35, so that the oscillating plate 17 not only can move side to side, but also can oscillate up and down. An upper end of the right locking rotation knob 36 is of a knob structure, and a lower end of the right locking rotation knob 36 is of a threaded rod structure. The right locking rotation knob 36 is mounted in the right threaded hole 1702 to form a thread pair, the left locking rotation knob 39 has the same structure as the right locking knob, and the left locking rotation knob 39 is mounted in the left thread hole 1703 to form a thread pair. Clockwise rotation of the left locking rotation knob 39 and the right locking rotation knob 36 can enable the lower ends of the left locking rotation knob 39 and the right locking rotation knob 36 to respectively press against the left sliding positioning block 40 and the right sliding positioning block 35, thereby locking up-down oscillation of the oscillating plate 17.

As shown in FIG. 3 and FIG. 5, a lower end of the movable positioning frame 29 is of a square plate 2901, an upper end of the movable positioning frame 29 is provided with a stepped plain shaft 2902, and the movable positioning frame 29 is internally provided with a through hole. The movable positioning frame 29 is mounted on an upper side of the sliding positioning groove 1701 and can move side to side. The input motor 18 is mounted at a lower side of the sliding positioning groove 1701, the square plate 2901 is fastened to the input motor 18 via four screws, and the square plate 2901 and the input motor 18 clamp the oscillating plate 17, thereby fixing the movable positioning frame 29. The position of the movable positioning frame 29 can be readjusted after loosening the four screws. Both the left oscillating arm 28 and the right oscillating arm 30 are of a platy structure, and rear ends of the left oscillating arm 28 and the right oscillating arm 30 are rotatably mounted on the plain shaft 2902. Two pulleys are coaxially arranged on the stepped pulley 23, and a diameter of a lower pulley is larger than that of an upper pulley. An upper end of the stepped pulley shaft 27 is coaxially fastened to the stepped pulley 23, the stepped pulley shaft 27 is coaxially and rotatably mounted inside the movable positioning frame 29, and a lower end of the stepped pulley shaft 27 is coaxially fastened to an output shaft of the input motor 18. An upper end of the upper left shaft 31 is provided with a left pulley 20, one square guide hole is vertically formed in a lower end of the upper left shaft 31, and the upper left shaft 31 is rotatably mounted at a front end of the left oscillating arm 28. An upper end of the lower left shaft 32 is of a square-rod structure, the square-rod structure is in fit with the square guide hole at the lower end of the upper left shaft 31 to form a prismatic pair. A lower end of the lower left shaft 32 is provided with an interface, and the interface can be connected to an input shaft of the steering gear. The left synchronous belt 21 is mounted between the left pulley 20 and the lower pulley of the stepped pulley 23 to form a synchronous transmission structure. An upper end of the upper right shaft 33 is provided with a right pulley 19, a square guide hole is vertically formed in a lower end of the upper right shaft 33, and the upper right shaft 33 is rotatably mounted on a front end of the right oscillating arm 30. An upper end of the lower right shaft 34 is of a square-rod structure, the square-rod structure is in fit with the square guide hole at the lower end of the upper right shaft 33 to form a prismatic pair. A lower end of the lower right shaft 34 is provided with an interface, and the interface can be connected to an input shaft of the steering gear. The right synchronous belt 22 is mounted between the right pulley 19 and the upper pulley of the stepped pulley 23 to form a synchronous transmission structure. The sealing cover 11 may be made of flexible rubber, thereby sealing the input motor 18, the left oscillating arm 28, the right oscillating arm 30, the synchronous belt transmission structure, and other components.

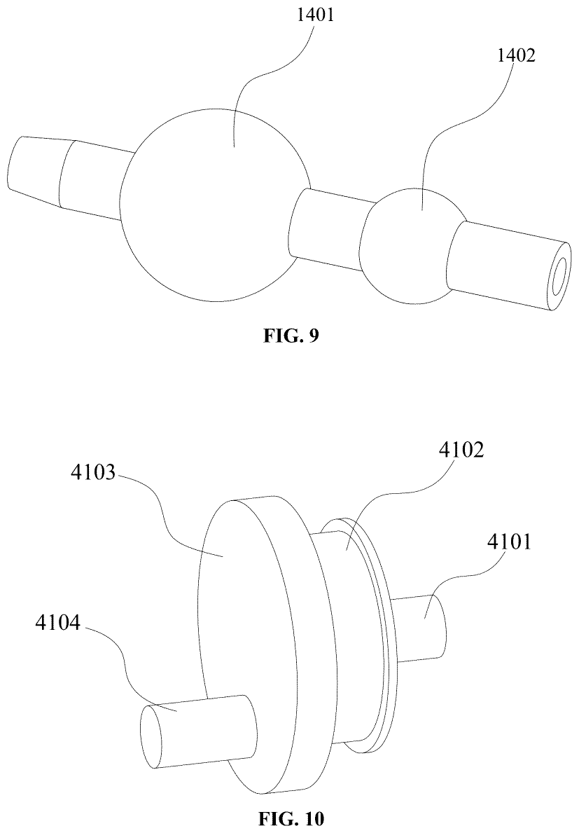

As shown in FIG. 6, FIG. 9 and FIG. 10, a front end of the nozzle 14 is provided with a spray orifice, a rear end of the spray orifice is provided with a positioning spherical surface 1401, a diameter of the positioning spherical surface is equal to that of the ball-and-socket structure in each of the front box wall and the rear box wall of the box body 1, an oscillating spherical surface 1402 is arranged behind the positioning spherical surface 1401, and a rear end of the oscillating spherical surface 1402 is provided with one interface. One nozzle 14 is mounted in each of seven ball-and-socket structures in the rear box wall of the box body 1, and each ball-and-socket structure is in fit with the corresponding positioning spherical surface 1401 to form a spherical pair. Seven small ball sockets are arranged inside an upper side of the oscillating plate 13, a lower side of the oscillating plate 13 is provided with two follower lugs 1301 which are symmetrical left and right, and the center of each follower lug 1301 is provided with a smooth round hole. Seven small ball sockets on the upper side of the oscillating plate 13 are respectively fitted with the oscillating spherical surfaces 1402 in the seven nozzles 14 to form a spherical pair. A right end of a first crankshaft wheel 41 is provided with one rotating shaft 4101, a left side of the rotating shaft 4101 is coaxially provided with one nozzle pulley 4102, a left side of the nozzle pulley 4102 is coaxially provided with a circular plate 4103, a left side of the circular plate 4103 is provided with a cylindrical actuating shaft 4104, the rotating shaft 4101 of the first crankshaft wheel 41 is rotatably mounted on the rear box wall of the box body 1, and the actuating shaft 4104 of the first crankshaft wheel 42 is in fit with the smooth round hole in the left follower lug 1301 to form a revolute pair and a prismatic pair. The second crankshaft wheel 41 has a same structure as the first crankshaft wheel 41, a rotating shaft of the second crankshaft wheel 42 is rotatably mounted on the rear box wall of the box body 1, and an actuating shaft of the second crankshaft wheel 42 is in fit with a smooth round hole in the right follower lug 1301 to form a revolute pair and a prismatic pair. The nozzle oscillating motor 45 is fixedly mounted inside the rear box wall of the box body 1, one drive wheel 44 is coaxially fastened to an output shaft of the nozzle oscillating motor 45, a first guide wheel 43 is rotatably mounted on the rear box wall of the box body 1 and located at a left side of the nozzle oscillating motor 45, and a second guide wheel 46 is rotatably mounted on the rear box wall of the box body 1 and located at a right side of the nozzle oscillating motor 45. The nozzle oscillating synchronous belt 47 is mounted among the first crankshaft wheel 41, the second crankshaft wheel 42, the first guide wheel 43, the drive wheel 44 and the second guide wheel 46, so that the nozzle oscillating motor 45 can simultaneously drive the first crankshaft wheel 41 and the second crankshaft wheel 42 to rotate through the nozzle oscillating synchronous belt 47, so that the oscillating plate 13 can drive the seven nozzles 14 on the rear box wall of the box body 1 to spray muddy water on a tested steering gear. Seven spiral hoses 10 are arranged on one end of the water inlet pipe 9 in a communication manner, and the spiral hose can extend, retract and twist to a certain extent. The other ends of the seven spiral hoses 10 are in corresponding communication with interfaces of rear ends of the seven nozzles 14 on the rear box wall of the box body 1, and the other end of the water inlet pipe 9 is in communication with a muddy water supply device. The muddy water supply device can provide a muddy water mixture with a certain pressure. A side sealing cover 5 is mounted on a rear side of the box body 1, and the side sealing cover 5 can shield and seal the oscillating plate 13, the spiral hose 10 and other components.

As shown in FIG. 3 and FIG. 6, one nozzle 14 is mounted in each of seven ball-and-socket structures inside the front box wall of the box body 1, and each ball-and-socket structure is in fit with the corresponding positioning spherical surface 1401 to form a spherical pair. One oscillating plate is also arranged on the front box wall of the box body 1, seven small ball sockets at the upper side of the oscillating plate are fitted with oscillating spherical surfaces 1402 in the seven nozzles to form spherical pairs. The first crankshaft wheel, the second crankshaft wheel, the first guide wheel, the nozzle oscillating motor, the drive wheel, the second guide wheel, the nozzle oscillating synchronous belt, the water inlet pipe and the spiral hose are also mounted on the front wall of the box body 1; and mounting positions and connection methods of the above parts are the same in a corresponding manner as those on the rear box wall of the box body 1, and the water inlet pipe on the outer side of the front box wall of the box body 1 is also in communication with a muddy water supply device. A side sealing cover is also arranged on the outer side of the front box wall of the box body 1.

The working process of a real-condition simulation test system for an automobile steering gear is briefly introduced as follows.

(1) The first steering gear 15 and the second steering gear 16 are fixed to the upper side of the mounting platform 108 via bolts, and are kept at a proper spacing. Afterwards, both ends of the first steering gear 15 are respectively connected to the first connecting frame 3 and the fourth connecting frame 8; and both ends of the second steering gear 16 are respectively connected to the second connecting frame 4 and the third connecting frame 12.

(2) The oscillating plate 17 is moved to a proper position, and the left positioning knob 38 and the right locking rotation knob 36 are tightened to lock a position of the oscillating plate 17.

(3) A tilt angle of the oscillating plate 17 is rotated to make the upper left shaft 31 and the upper right shaft 33 parallel to the input shafts of the first steering gear 15 and the second steering gear 16; and the left locking rotation knob 39 and the right locking rotation knob 36 are tightened to lock the tilt angle of the oscillating plate 17.

(4) The position of the movable positioning frame 29 is adjusted, and the left oscillating arm 28 and the right oscillating arm 30 are rotated to make the upper left shaft 31 and the upper right shaft 33 respectively aligned with the input shafts of the two steering gears; and four screws between the input motor 18 and the movable positioning frame 29 are tightened to fix the position of the movable positioning frame 29.

(5) The lower left shaft 32 and the lower right shaft 34 extend downwards to make the interface at the lower end of the lower left shaft 32 to connect with the input shaft of the first steering gear 15 and to make the interface at the lower end of the lower right shaft 34 to connect with the input shaft of the second steering gear 16.

(6) The left cover 6 and the right cover 7 are closed, and magnetic field intensities inside four dampers 2 are set according to parameters of the steering gears, thereby regulating resistance values of the four dampers 2. The nozzles 14 on the front and rear sides inside the box body 1 spray the muddy water mixture while oscillating, and the input motor 18 can drive test operations of the two steering gears through a synchronous belt transmission structure.

What is claimed is:

1. A real-condition simulation test system for an automobile steering gear, comprising a box body, a damper, a first connecting frame, a left cover, a right cover, water inlet pipes, spiral hoses, a sealing cover, an oscillating plate, nozzles, an oscillating plate, an input motor, a stepped pulley, an end connector, a threaded hole slider, a left oscillating arm, a movable positioning frame, a right oscillating arm, an upper left shaft, a lower left shaft, an upper right shaft, a lower right shaft, a right sliding positioning block, a right locking rotation knob, a right positioning knob, a left positioning knob, a left locking rotation knob, and a left sliding positioning block, wherein a front T-shaped groove and a rear T-shaped groove are arranged in a front side and a rear side inside the box body, respectively; seven ball-and-socket structures are arranged on each of a front box wall and a rear box wall of the box body; a mounting platform is arranged at a middle position of a bottom of the box body, two beveled structures are arranged on each of a left side and a right side of the mounting platform, and a bottom end of each of the two beveled structures is transversely provided with a water filter hole and a water outlet pipe; seven nozzles are arranged on each of a front sidewall and a rear sidewall of the box body, and each of the seven nozzles is capable of spraying a mud-water mixture while oscillating; two water inlet pipes are arranged on a front side and a rear side of the box body, and each of the two water inlet pipes is in communication with corresponding nozzles through seven spiral hoses; and the left cover and the right cover are mounted at an upper end of the box body via hinges;
a triangular arc plate at a left end of the first connecting frame and a first annular frame at a right end of the first connecting frame are connected to a whole via three circular guide rods in the first connecting frame, a first rotating frame is mounted at a right side of the first annular frame to form a revolute pair; the threaded hole slider is mounted inside the first rotating frame to form a prismatic pair; the end connector is positioned through the acorn nut and the threaded hole slider; a cavity inside the damper is filled with magnetorheological fluid, and an electromagnetic coil is arranged inside a sidewall of the damper; a piston plate at a middle position of a damping guide rod is provided with three through holes, the piston plate is configured to divide the magnetorheological fluid inside the damper into a left portion and a right portion, and resistance of the damper is adjustable by a magnetic field intensity of the electromagnetic coil; the damper is located at a center position of the first connecting frame, and two ends of the damping guide rod are fastened to two ends of the first connecting frame; the first connecting frame is mounted on a left sidewall of the box body to form a prismatic pair, and the damper inside the first connecting frame is fixedly connected to the box body; the first connecting frame, the first rotating frame, the threaded hole slider, the acorn nut, the end connector and the damper form a set of resistance guiding and adjusting device; two sets of the resistance guiding and adjusting devices are mounted on each of the left sidewall and a right sidewall of the box body; a first steering gear and a second steering gear are fixedly mounted on the mounting platform, and both ends of each of the first steering gear and the second steering gear are connected to corresponding resistance guiding and adjusting devices, respectively;
a sliding positioning groove is formed in a middle position of the oscillating plate, two ends of the oscillating plate are rotatably connected to the left sliding positioning block and the right sliding positioning block, respectively, the left sliding positioning block and the right sliding positioning block are respectively mounted in the rear T-shaped groove and the front T-shaped groove to form prismatic pairs; the left positioning knob and the right positioning knob are configured to lock positions of the left sliding positioning block and the right sliding positioning block by thread structures, respectively; the left locking rotation knob and the right locking rotation knob are mounted at two ends of the oscillating plate and configured to lock a tilt angle of the oscillating plate by thread structures; the movable positioning frame and the input motor are mounted at an upper side and a lower side of the sliding positioning groove, respectively; and rear ends of the left oscillating arm and the right oscillating arm are both rotatably mounted on the movable positioning frame; two pulleys are coaxially arranged on the stepped pulley, and the stepped pulley is fastened to an output shaft of the input motor through a stepped pulley shaft; the upper left shaft and the upper right shaft are rotatably mounted on front ends of the left oscillating arm and the right oscillating arm, respectively; the stepped pulley is configured to drive the upper left shaft and the upper right shaft to rotate through two synchronous belts; upper ends of the lower left shaft and the lower right shaft are respectively mounted inside the upper left shaft and the upper right shaft and capable of extending or retracting; and lower ends of the lower left shaft and the lower right shaft are connected to input shafts of the first steering gear and the second steering gear, respectively.

2. The real-condition simulation test system for an automobile steering gear according to claim 1, wherein a plurality of inclined through drainage holes are arranged below each of the front T-shaped groove and the rear T-shaped groove; an upper end of each drainage hole is in communication with an inside of the front T-shaped groove or in communication with an inner of the rear T-shaped groove; and a lower end of each drainage hole is in communication with the inside of the box body; the drainage hole is capable of guiding muddy water in a side T-shaped groove into the box body.

3. The real-condition simulation test system for an automobile steering gear according to claim 1, wherein an annular T-shaped groove is arranged inside the right side of the first annular frame, two arc sliders are arranged on two ends of a left side of the first rotating frame, and the two arc sliders are mounted in the annular T-shaped groove inside the first annular frame, thereby enabling the first rotating frame to rotate freely; and a straight T-shaped groove is arranged inside a right side of the first rotating frame.

4. The real-condition simulation test system for an automobile steering gear according to claim 1, wherein two pulleys are coaxially arranged on the stepped pulley, and a diameter of a lower pulley of the two pulleys is greater than a diameter of an upper pulley of the two pulleys.

5. The real-condition simulation test system for an automobile steering gear according to claim 1, wherein the input motor, the left oscillating arm, the right oscillating arm and related connecting components are sealed by a sealing cover, and the sealing cover is made of flexible rubber.

6. The real-condition simulation test system for an automobile steering gear according to claim 1, wherein a front end of the nozzle is provided with a spray orifice, a rear end of the spray orifice is provided with one positioning spherical surface, an oscillating spherical surface is arranged behind the positioning spherical surface, and a rear end of the oscillating spherical surface is provided with one interface.

7. The real-condition simulation test system for an automobile steering gear according to claim 1, wherein each of the left cover and the right cover is provided with a transparent observation window.
